(19) United States
(12) Patent Application Publication
(10) Pub. No.: US 2016/0208203 A1
(43) Pub. Date: Jul. 21, 2016

(54) ELECTRICAL CIRCUIT FOR TOY SOAP

(71) Applicants: Christopher V. Traynor, Sarasotta, FL (US); Daniel H. Traynor, Sarasotta, FL (US)

(72) Inventors: Christopher V. Traynor, Sarasotta, FL (US); Daniel H. Traynor, Sarasotta, FL (US)

(21) Appl. No.: 14/914,043

(22) PCT Filed: Aug. 26, 2014
(86) PCT No.: PCT/US14/52663

§ 371 Date: Feb. 24, 2016

Related U.S. Application Data
(60) Provisional application No. 61/870,175, filed on Aug. 26, 2013.

(51) Int. Cl. C11D 17/04; A63H 33/26

(52) U.S. Cl. CPC C11D 17/048; A63H 33/26

(57) ABSTRACT

A soap bar has a solid or semi-solid matrix comprising a cleaning composition; and one or more articles positioned in the matrix. The articles include an electrical power source, an output device, a switching device, a controller and a pair of electrodes in spaced apart relationship. The pair of electrodes are in electrical communication with the electrical power source and the output device. The output device produces an output when a conductive material creates a current path between the pair of electrodes. A section of the matrix covers the pair of electrodes and prevents the conductive material from creating the current path until the section of the matrix is removed thereby uncovering the pair of electrodes. A sensor device may also be included to create the current path between the pair of electrodes.

### CROSS-REFERENCES TO RELATED APPLICATIONS

The application claims priority from U.S. Patent Application No. 61/870,175 filed Aug. 26, 2013.

### STATEMENT REGARDING FEDERALLY SPONSORED RESEARCH

Not Applicable.

### BACKGROUND OF THE INVENTION

1. Field of the Invention

This invention relates to a soap bar including a cleaning composition, and a circuit including a sensor and an output device, the output device producing an output such as visible light, vibration, or a sound, the output device is controlled by a control circuit.

2. Description of the Related Art

Solid soaps for years have had different shapes, fragrances, formulations, textures, and marketing appeal. Formulations have been developed to include melt and pour, alcohol, and base.

Translucent soaps are available. Example translucent soaps include soaps which contain glycerin. It has been reported that the clarity of glycerin soaps is due to the alignment of the soap molecules, which can be induced through the addition of alcohol and sugar.

Clear glycerin soap bases can be made by combining glycerin or various polyols with soap and/or other surfactants. These clear glycerin soaps are easily remelted and remolded, and are often sold to consumers for melt-and-pour soap crafting.

Glycerin soap can also be made by melting and continuously heating soap that has been partially dissolved in an alcohol solution until the mixture reaches a clear, gel-like consistency. The alcohol is heated with a sugar solution until the soap is transparent or translucent, and then the soap is molded at a reduced temperature.

Glycerin types of soaps are not as commonplace on the market; however, these soaps offer advantages when it comes to producing a clear soap. The clear soaps which contain solvents or glycerin to make a semi transparent soap offer some visibility; however, these soaps may have some clouding associated with the formulation.

While transparent and translucent soaps are currently available, there is still a need for a soap product that takes further advantage of the transparency or translucency of various soap formulations.

### SUMMARY OF THE INVENTION

In one aspect, the present disclosure provides a soap bar including a solid or semi-solid matrix comprising a cleaning composition. The matrix is transparent or translucent, and an article is positioned in the matrix. The article includes a pair of electrodes in spaced apart relationship. The pair of electrodes are connected, via a circuit path, to an electrical power source, an output device, a controller, and a switching device. The switching device provides an input signal to the controller when a conductive material creates a current path between the pair of electrodes. The controller, receives an input signal from the switching device, and provides a current path between the electrical power source and the output device. A section of the matrix covers the pair of electrodes and prevents the conductive material from creating the current path until the section of the matrix is removed thereby uncovering the pair of electrodes. A resistor can load the switching device to restrict the output device from outputting a signal before the matrix is removed.

In another aspect, the invention provides a soap bar including a solid or semi-solid matrix comprising a cleaning composition. A circuit is positioned in the matrix and includes a pair of electrodes that are in a spaced apart relationship. The pair of electrodes are in a circuit path with an electrical power source, an output device, a controller and a switching device. The switching device provides an input signal to the controller when a conductive material creates a current path between the pair of electrodes. The controller, receiving an input signal from the switching device, provides a current path between the electrical power source and the output device. A section of the matrix covers the pair of electrodes and prevents the conductive material from creating the current path until the section of the matrix is removed thereby uncovering the pair of electrodes. At least one of a plurality of capacitors can be in the current path between the electrodes, the at least one of a plurality of capacitors can restrict the output device from outputting a signal before the matrix covering the pair of electrodes is removed.

In yet another aspect, the invention provides a soap bar including a solid or semi-solid matrix comprising a cleaning composition. An article is positioned in the matrix, and the article includes a pair of electrodes in spaced apart relationship. The pair of electrodes is in a circuit path with an electrical power source an output device, a controller, a switching device and a sensor device. The switching device provides an input signal to the controller when a conductive material creates a current path between the pair of electrodes. The controller, receiving an input signal from the switching device, provides a current path between the electrical power source and the output device. The sensor device creates the current path between the electrodes when sensing light.

In still another aspect, the invention provides a soap bar including a solid or semi-solid matrix comprising a cleaning composition. An article is positioned in the matrix, and the article includes a pair of electrodes in spaced apart relationship. The pair of electrodes is in a circuit path with an electrical power source an output device, a controller, a switching device and a sensor device. The switching device provides an input signal to the controller when a conductive material creates a current path between the pair of electrodes. The controller, receiving an input signal from the switching device, provides a current path between the electrical power source and the output device. The sensor device creates the current path between the electrodes when sensing a temperature change.

In yet another aspect, the invention provides a soap bar including a solid or semi-solid matrix comprising a cleaning composition. An article is positioned in the matrix, and the article includes a pair of electrodes in spaced apart relationship. The pair of electrodes is in a circuit path with an electrical power source an output device, a controller, a switching device and a sensor device. The switching device provides an input signal to the controller when a conductive material creates a current path between the pair of electrodes. The controller, receiving an input signal from the switching device, provides a current path between the electrical power source and the output device. The sensor device creates the current path between the electrodes when sensing a pressure change.

In still another aspect, the invention provides a soap bar including a solid or semi-solid matrix comprising a cleaning composition. An article is positioned in the matrix, and the article includes a pair of electrodes in spaced apart relationship. The pair of electrodes is in a circuit path with an electrical power source an output device, a controller, a switching device and a sensor device. The switching device provides an input signal to the controller when a conductive material creates a current path between the pair of electrodes. The controller, receiving an input signal from the switching device, provides a current path between the electrical power source and the output device. The sensor device creates the current path between the electrodes when an orientation of the soap bar changes.

It should be known that the output device in the above embodiments can be, but is not limited to, a light emitting device, a sound emitting device, a vibration emitting device or any combination thereof.

In yet another aspect, the invention provides a melt and pour soap bar formulation including a transparent or translucent cleaning composition, and a plurality of dispersed articles, wherein the articles comprise a light source that produces visible light. The formulation is solid below 120° F., and the formulation can be remelted and remolded.

In still another aspect, the invention provides a melt and pour soap bar formulation including a cleaning composition, and a plurality of dispersed articles, wherein the articles comprise a sound emitting device. The formulation is solid below 120° F., and the formulation can be remelted and remolded.

With a ultra clear soap like a melt and pour or alcohol based soap bar, one can add articles having a light source (such as a glowing material) or a sound emitting device of different constructions to the center of the soap bar which in turn exhibits its sound and/or illuminating properties through the transparent or translucent formulation better than other soap types.

These and other features, aspects, and advantages of the present invention will become better understood upon consideration of the following detailed description, drawings and appended claims.

### BRIEF DESCRIPTION OF THE DRAWINGS

FIG. 1 is a top front perspective view of one example embodiment of a soap bar according to the invention.

FIG. 2 is a cross-sectional view of the soap bar of FIG. 1 taken along lines 2-2 of FIG. 1.

FIG. 3 is a cross-sectional view similar to FIG. 2 of another example embodiment of a soap bar according to the invention.

FIG. 4 is a cross-sectional view similar to FIG. 2 of yet another example embodiment of a soap bar according to the invention.

FIG. 5 is a cross-sectional view similar to FIG. 2 of still another example embodiment of a soap bar according to the invention.

FIG. 6 is a detailed cross-sectional view similar to FIG. 2 of one example dispersed article of the soap bar of FIG. 1.

FIG. 7 is a cross-sectional view similar to FIG. 2 of yet another example embodiment of a soap bar according to the invention.

FIG. 8 is a cross-sectional view of the soap bar of FIG. 7 with the soap bar rotated 180 degrees.

FIG. 9 is a detailed cross-sectional view similar to FIG. 2 of another example dispersed article of the soap bar.

FIG. 10 is a detailed schematic of the electrical control circuit for an example dispersed article of the soap bar.

FIG. 11 is a detailed schematic of the electrical control circuit for an example dispersed article of the soap bar, further showing the inclusion of a resistor into the circuit.

FIG. 12 is a detailed schematic of the electrical control circuit for an example dispersed article of the soap bar, further showing the inclusion of a plurality of capacitors into the circuit.

FIG. 13 is a detailed schematic of the electrical control circuit for an example dispersed article of the soap bar, further showing the inclusion of a sensor device into the circuit.

Like reference numerals will be used to refer to like parts from Figure to Figure in the following description of the drawings.

### DETAILED DESCRIPTION OF THE INVENTION

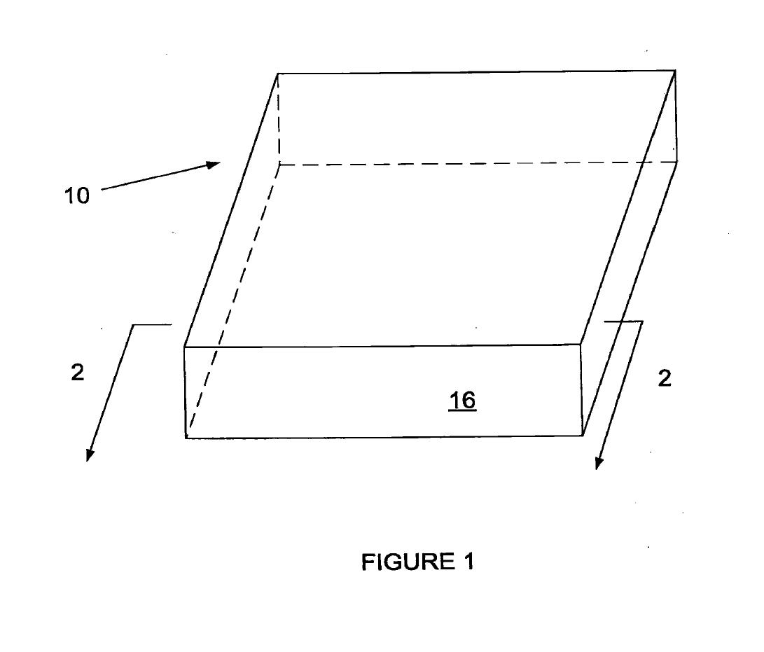

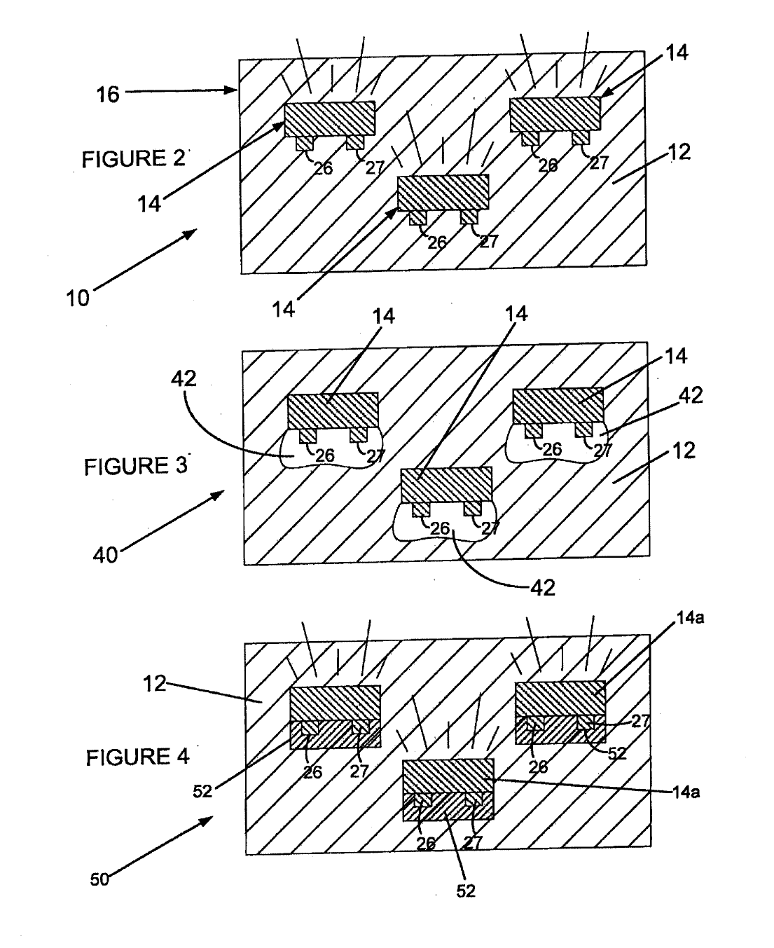

Referring first to FIGS. 1 and 2, one embodiment of a soap bar 10 of the present invention is shown. A cleaning composition 12 is shown encapsulating a plurality of dispersed articles 14. The dispersed articles 14 are preferably suspended within the cleaning composition 12 but may optionally be positioned such that the dispersed articles 14 are in contact with an outer surface 16 of the soap bar 10. Preferably the dispersed articles 14 be distributed evenly throughout the entire soap bar 10.

### A. Cleaning Composition

The cleaning composition 12 forms a solid or semi-solid matrix which at least partially encompasses each of the dispersed articles 14. In one non-limiting embodiment, the cleaning composition 12 has a total weight of about 99% of the soap bar 10, and the dispersed articles 14 have a total weight of about 1% of the soap bar 10. In another non-limiting embodiment, the cleaning composition 12 has a total weight of about 75% of the soap bar 10, and the dispersed articles 14 have a total weight of about 25% of the soap bar 10. In another non-limiting embodiment, the cleaning composition 12 has a total weight of about 50% of the soap bar 10, and the dispersed articles 14 have a total weight of about 50% of the soap bar 10. In another non-limiting embodiment, the cleaning composition 12 has a total weight of about 25% of the soap bar 10, and the dispersed articles 14 have a total weight of about 75% of the soap bar 10. In another non-limiting embodiment, the cleaning composition 12 has a total weight of about 10% of the soap bar 10, and the dispersed articles 14 have a total weight of about 90% of the soap bar 10. The cleaning composition 12 may comprise the majority of the soap bar 10 by weight. The cleaning composition 12 is preferably a solid of a hardness such that the soap bar 10 retains its shape and is self supporting after molding from a flowable mass.

The cleaning composition 12 includes one or more surfactants which provide lather and assist in the removal of soils. Preferably, the surfactants should be sufficiently mild to skin and eyes to be suitable for everyday use in cleaning the body. However, the cleaning composition is not limited to cleaning the body. For example, it can be used for washing pools, ponds and the like.

Anionic surfactants are suitable for use as one or more of the surfactants in the cleaning composition 12. Anionic surfactants can comprise about 2% to about 60%, or about 2% about 45%, or about 5% to about 35% by weight of the cleaning composition 12.

A soap that can disperse in water is one example anionic surfactant. Non-limiting example water-dispersable soaps include C₆-C₁₄ saturated fatty acid soaps and C₁₆-C₁₈ unsaturated and polyunsaturated fatty acid soaps, and mixtures and combinations thereof. These water-dispersable soaps can be derived from fats such as tallow, coconut oil, palm kernel oil, laurel oil, olive oil, and canola oil. The term “soap” means the alkali metal or alkanol ammonium salts of aliphatic alkane- or alkene monocarboxylic acids. Soaps may be made by soap manufacturing processes wherein natural fats and oils such as tallow or coconut oil or their equivalents are saponified with an alkali metal hydroxide. Alternatively, the soaps may be made by neutralizing fatty acids, such as lauric (C₁₂), myristic (C₁₄), palmitic (C₁₆), or stearic (C₁₅) acids with an alkali metal hydroxide or carbonate or alkanolamide.

A synthetic surfactant is another example anionic surfactant. The synthetic anionic surfactant may be an aliphatic sulfonate, such as a primary alkane (e.g., C₈-C₂₂) sulfonate, primary alkane (e.g., C₈-C₂₂) disulfonate, C₈-C₂₂ alkene sulfonate, C₈-C₂₂ hydroxyalkane sulfonate or alkyl glyceryl ether sulfonate. The synthetic anionic surfactant may also be an alkyl sulfate (e.g., C₁₂-C₁₈ alkyl sulfate) or alkyl ether sulfate. The synthetic anionic surfactant may also be C₁₀ to C₁₈ alkyl sulfosuccinates; alkyl and acyl taurates, alkyl and acyl sarcosinates, fatty N-acyl amino acid salts, sulfoacetates, C₈-C₂₂ alkyl phosphates, alkyl phosphate esters and alkoxyl alkyl phosphate esters, acyl lactates, C₈-C₂₂ monoalkyl succinates and maleates, sulphoacetates, and acyl isethionates, and the like.

Amphoteric surfactants are suitable for use as one or more of the surfactants in the cleaning composition 12. Amphoteric surfactants include at least one acid group. This acid group may be a carboxylic or a sulphonic acid group. They also include quaternary nitrogen and therefore are quaternary amido acids. The amphoteric surfactant can be a sulphobetaine. One example sulfobetaine is cocoamidopropyl hydroxy sultaine. Amphoacetates and diamphoacetates are useful, such as sodium lauroamphoacetate, sodium cocoamphoacetate, and blends thereof, and the like. Other example amphoteric surfactants are alkyl betaines such as cocobetaine, or alkylamidoalkyl betaines, such as cocoamidoproyl betaine or mixtures thereof. Example levels of amphoteric surfactant in the cleaning composition 12 by weight are in the range from about 1% to about 15%.

Nonionic surfactants are suitable for use as one or more of the surfactants in the cleaning composition 12. When present, nonionic surfactants may be used at levels from 1% to about 50%, or about 1% to about 25%, or from about 1% to about 10% by weight of the cleaning composition 12. Non-limiting examples of nonionic surfactants are (C₁₂-C₂₂) fatty alcohol-ethylene oxide condensates. The nonionic surfactant may also be a C₁₀ to C₁₆ fatty alkanol amide such as cocamide MEA. Other types of suitable nonionic surfactants are alkyl glycosides and alkylipolyglycosides which can be broadly defined as condensates of long chain alcohols, e.g., C₈-C₃₀ alcohols, with sugars or starches, i.e., glycosides or polyglycosides. Other useful nonionic surfactants include polyhydroxy fatty acid amide surfactants, or amine oxides.

Cationic surfactants are suitable for use as one or more of the surfactants in the cleaning composition 12. Cationic surfactants may be used from about 1% to about 20%, or from about 1% to about 10%, or from about 1% to about 5% by weight of the cleaning composition 12. Examples of cationic surfactants are the quaternary ammonium compounds such as alkyldimethylammonium halides.

In addition to one or more surfactants, the cleaning composition 12 can include various optional ingredients such as water-soluble solvents, colorants, benefit agents, and structuring agents.

Non-limiting examples of water soluble organic solvents are C₁-C₁₀ mono- or polyhydric alcohols and/or their alkoxylated ethers. Examples of this group include ethanol, isopropanol, propanol, butanol, propylene glycol, ethylene glycol monoethyl ether, hexylene glycol, glycerin (propane-1,2,3-triol), sorbitol and mixtures thereof. Another group of suitable water soluble organic solvents include polyalkylene oxides such as polyethylene oxide and polypropylene oxide. Another type of water soluble organic solvent is an alkanolamine such as triethanolamine. The water soluble organic solvent(s) may be present at a level of from 0 to about 50%, or from about 2 to about 35%, or from about 2% to 30% based on the total weight of the cleaning composition 12.

Non-limiting examples of colorants include: (1) the various FD&C dyes and their mixtures, or (2) colorants from vegetable and mineral sources such as green tea, ground henna, indigo root; kelp, poppy seeds, sage, sea clay, seaweeds, tumeric, yellow illite, and mixtures thereof. The level of colorant depends on the desired transparency or translucency.

The cleaning composition 12 may include a benefit agent that provides some sensory or functional benefit that is delivered during or after the cleansing process. Non-limiting examples of benefit agents are: (i) fragrances, (ii) lipids that are useful in skin barrier function and repair such as cholesterol, (iii) fat soluble vitamins such as vitamin A, vitamin B-3, and vitamin E, (iv) UV A and UV B absorbers (sunscreens) such as octyl methoxy cinnamate and butyl methoxy benzoylmethane, (v) anti-aging agents such as retinol esters, and fatty long chain alpha hydroxy acids, (vi) antioxidants used to reduce photodamage and premature damage due to excessive oxidation such as Vitamin E acetate, (vii) moisturizers, and (viii) insect repellents, pesticides, and/or insecticides. Any mixture of these benefit agents can comprise from about 0.0001% to about 20%, or from about 0.05% to about 15%, or from 0.1% to about 10% by weight of the cleaning composition 12.

The cleaning composition 12 may include a structuring agent. Structuring of the cleaning composition 12 is often provided by the surfactants themselves. However, in some circumstances additional structuring agents prove useful and can be employed in the invention at levels between about 0.5% and about 15% by weight, or between about 1% and about 10% by weight of the cleaning composition 12. Non-limiting examples of structuring agents include: (i) monoglycerides, diglycerides, and triglycerides such as hydrogenated cotton seed oil, (ii) sugars, (lii) thermosetting polymers such as gelatin and carrageenan, and (iv) fillers such as inorganic minerals (e.g., calcium sulfate and the like), starches, and waxes.

The surfactant system and various optional ingredients are chosen so as to provide a translucent or transparent matrix of the cleaning composition 12. A transparent matrix is one that allows for viewing of objects behind it. A translucent matrix is one which allows light to pass through it but the light may be scattered such that it will not be completely possible to clearly identify objects behind the translucent matrix. Preferably, the cleaning composition is a low cloud point composition.

The level of transparency or translucency of a matrix can be quantified by the measurement of light transmittance using for example a spectrophotometer. For example, different samples of the cleaning composition 12 of a constant thickness can be prepared, and the % transmittance of light, from 400-800 nanometers, through the samples can be measured. In an opaque cleaning composition (i.e., non-translucent), the transmittance of light through a sample is zero, while in a translucent or transparent cleaning composition, a progressively larger amount of light is transmitted.

Refractive index values can also be used to quantify the level of transparency or translucency of a matrix. In one form, the matrix has a refractive index range of 1.41-1.50. In another form, the matrix has a refractive index range of 1.31-1.40. In another form, the matrix has a refractive index range of 1.21-1.30. In another form, the matrix has a refractive index range of 1.11-1.20. In another form, the matrix has a refractive index range of 1.0-1.10. The transmittance of the matrix can suggest cloud points no greater than a certain value.

### B. Dispersed Articles

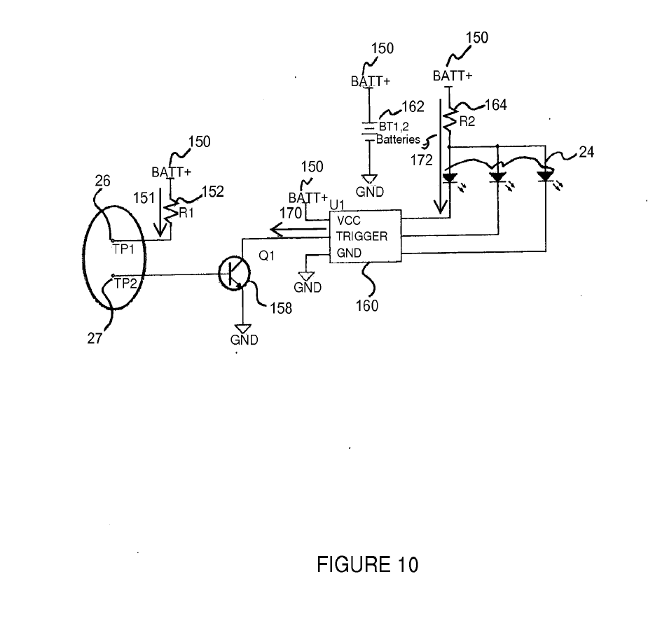

Referring to FIG. 2, the articles 14 are shown dispersed in the cleaning composition 12. The articles 14 are also shown in more detail in FIGS. 6 and 10. The articles 14 include an electrical power source 22, such as a battery or photovoltaic cell. The articles 14 include an output device 24 that produces an output as a result of an electric current from the electrical power source 22 being passed through the output device 24. A light emitting diode is one suitable output device 24. A sound emitting device or a vibration emitting device are also suitable output devices 24. In other implementation, the output device 24 may includes a wireless transmitter configured to transmit a signal to a separate device, where the separate device is configured to receive the wireless signal and generate a corresponding output. For example, the output device 24 may output a signal over an 802.11 wireless communications network, Bluetooth network, and the like, that may be received by a device, such as a smart phone or computer system (e.g., a desktop computer, laptop computer, or tablet computer). Upon receipt of the signal, the smart phone device can generate a suitable output, such an audible or visual output. A pair of electrodes 26, 27 are arranged in a spaced apart relationship. The pair of electrodes 26, 27 are in electrical communication with the electrical power source 22 and the output 24 by way of electrical leads 28a, 28b, 28c. A housing 29 can keep the electrical power source 22, the output device 24, the electrodes 26, 27, and the electrical leads 28a, 28b, 28c assembled together.

When a user washes an object with the soap bar 10 of FIGS. 1, 2 and 4, the cleaning composition 12 will dissolve in a solvent, typically water. When enough of the cleaning composition 12 dissolves, the water will create a current path between the electrodes 26, 27 and the output device 24 will produce an output. Thus, a section of the matrix of the cleaning composition 12 covers the pair of electrodes 26, 27 and prevents the conductive material (e.g., water) from creating the current path until the section of the matrix is removed by dissolution thereby uncovering the pair of electrodes 26, 27. The conductive material that creates the current path between the pair of electrodes 26, 27 is not limited to the solvent that dissolves cleaning composition 12. For example, water may dissolve the cleaning composition 12, but the conductive material may be a person's skin that creates the current path between the pair of electrodes 26, 27.

In this manner, soap bar 10 may operate as a toy or novelty that can incentivize users and, particularly children, to use the soap 10 to improve personal hygiene. Also, even after the cleaning composition of soap 10 is fully consumed, articles 14 may still be usable as toys or other devices and can be operated even in an absence of soap. Soap bar 10 may take any form so as to be useful. In some cases, soap bar 10 is combined with other objects or structures, such as ropes or sticks, to assist in the use of soap bar 10 or the hanging of soap bar 10 for storage.

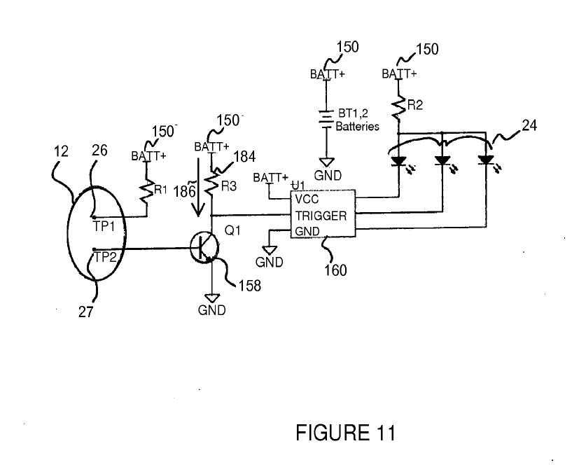

Turning now to FIG. 10, there is a detailed schematic of a exemplary dispersed article 148. The article 148 includes a number of electronic components that may be implemented as separate and distinct devices or, in other implementations, any number of the components or devices of article 148 (as well as the articles of FIGS. 11, 12, and 13, described below) may be incorporated into a single integrated circuit or chip. Article 148 includes a battery 162 or other power supply, such as a photovoltaic cell, a switching device 158, a controller 160, and an output device 24 exemplified as LED type lighting elements, although other output devices such as vibration or sound emitting devices could also be used in the present invention. When article 148 includes a photovoltaic cell, in some implementations, when the soap bar is first manufactured, soap material is configured to cover the photovoltaic cell, wherein the soap material blocks sufficient light that the photovoltaic cell (and, thereby article 148) is not capable of operating. However, after user, and when sufficient soap material has been removed that light can penetrate the soap material to the photovoltaic cell, the photovoltaic cell may provide sufficient electrical energy that article 148 can operate. In this implementation, the translucence of the soap material can be selected to control how much soap material must be removed before article 148 is operative.

The output device 24 can be a single LED type element or a plurality of LED type elements. The LED type elements may all be of the same or different colors. The LED type elements may be illuminated together in a continuous fashion, or may be illuminated in various flashing patterns in which only a subset of the LED type elements are illuminated at a particular time. When a conductive path is created between the pair of electrodes 26, 27, a first current 151 flows from a positive battery terminal 150 though a current limiting resistor 152 (in one implementation resistor 152 has a resistance of about 1 mega ohm) to the switching device 158. A sensitivity of article 148 can be controlled by selecting an appropriate resistance value for resistor 152. By reducing the amount of resistance, the sensitivity of the article 148 can be increased. Conversely, by increasing the resistance of resistor 152, the sensitivity of the article 148 can be reduced. A reduction in sensitivity of the device may be useful to prevent the article 148 from triggering due to false input signals, such as those that may be generated by excessive humidity causing a current path to be formed along the pair of electrodes 26 and 27.

When the current flow 151 reaches a pre-determined threshold value, the current flow 151 will forward bias the switching device 158, causing the switching device 158 to become conductive. When switching device 158 turns on a second current 170 to flow from the controller 160 to a common point (e.g., a ground node) 168, through the switching device 158.

Upon detecting the increase in the magnitude of current flow 190, the controller 160 will then energize the output device 24, allowing a third current 172 to flow from the positive battery terminal 150 through a current limiting resistor 164 (in one implementation resistor 164 has a resistance of about 33 ohms) and the output device 24.

In a further embodiment, the battery 162 may be a plurality of batteries connected in series or parallel to provide the required voltage and current for the output device 24.

In the exemplary embodiment, the switching device is illustrated to be a Bi-polar Junction Transistor (“BJT”) type transistor, in which case one of the pair of electrodes 26, 27 is connected to a base of the transistor. It should be known that, the switching device can be a transistor such as a MOSFET, CMOS or any other known type of transistor suitable for the present invention.

Turning now to FIG. 3, there is a cross-sectional view of another example embodiment of a soap bar 40 according to the invention. Articles 14 are shown dispersed in the cleaning composition 12. Under some circumstances, the cleaning composition 12 may have a conductivity sufficient to create the current path between the pair of electrodes 26, 27. In order to avoid emission of an output signal from the output device 24 before use by a consumer, an air pocket 42 is created around the electrodes 26, 27. This provides an electrically insulating gap between the electrodes 26, 27. When enough of the cleaning composition 12 dissolves, the water will enter the pocket 42 create a current path between the electrodes 26, 27, and the output device 24 will produce an output signal. Thus, the air pocket 42 prevents an output signal by the output device 24 before use by a consumer.

Turning now to FIG. 4, there is a cross-sectional view of another example embodiment of a soap bar 50 according to the invention. Articles 14a are shown dispersed in the cleaning composition 12. As detailed above, certain cleaning compositions 12 may have a conductivity sufficient to create the current path between the pair of electrodes 26, 27. In order to avoid an output signal from the output device 24 before use by a consumer, a non-conductive dissolvable film 52 is arranged on the electrodes 26, 27 of the articles 14a. This provides an electrically insulating film 52 between the electrodes 26, 27. When enough of the cleaning composition 12 and the film 52 dissolves, the water will create a current path between the electrodes 26, 27, and the output device 24 will produce an output signal. However, the film 52 prevents an output signal by the output device 24 before use by a consumer. Various materials are suitable for use in the electrically insulating film 52. Non-limiting example materials include gels, glycerin, sodium compounds, stearic acid, polyvinyl alcohol, and lipids with a low melting point. Preferably, the film 52 is a polar material that electrically insulates the electrodes 26, 27 and that will dissolve in a polar material such as water. The film 52 should not dissolve in the cleaning composition 12, or should only minimally dissolve in the cleaning composition 12.

In another embodiment of the invention, film 52 is a non-dissolvable film that increases conductivity upon a temperature change. When the film 52 becomes more conductive due to a temperature change, a current path is created between the electrodes 26, 27, and the output device 24 will produce an output signal. For example, the film may be a sintered metal oxide commonly used in a negative temperature coefficient thermistor. These materials increase in conductivity upon a temperature increase such as provided by water above room temperature.

In another embodiment of the invention, film 52 is a non-dissolvable film that becomes conductive upon application of pressure. When the film 52 becomes conductive due to a pressure change, a current path is created between the electrodes 26, 27, and the output device 24 will produce an output signal. Polyvinylidene fluoride is material that could exhibit conductivity upon application of pressure, such as the pressure from a user's hands.

In another embodiment of the invention, film 52 is a dissolvable film that upon dissolving uncovers a photoconductive material that becomes conductive upon application of light. For example, a photoconductive polymer such as polyvinylcarbazole can be placed under an opaque dissolvable film 52. The photoconductive polymer is in contact with the electrodes 26, 27. When the film 52 dissolves in water, light contacting the photoconductive material creates a current path between the electrodes 26, 27, and the output device 24 will produce an output signal.

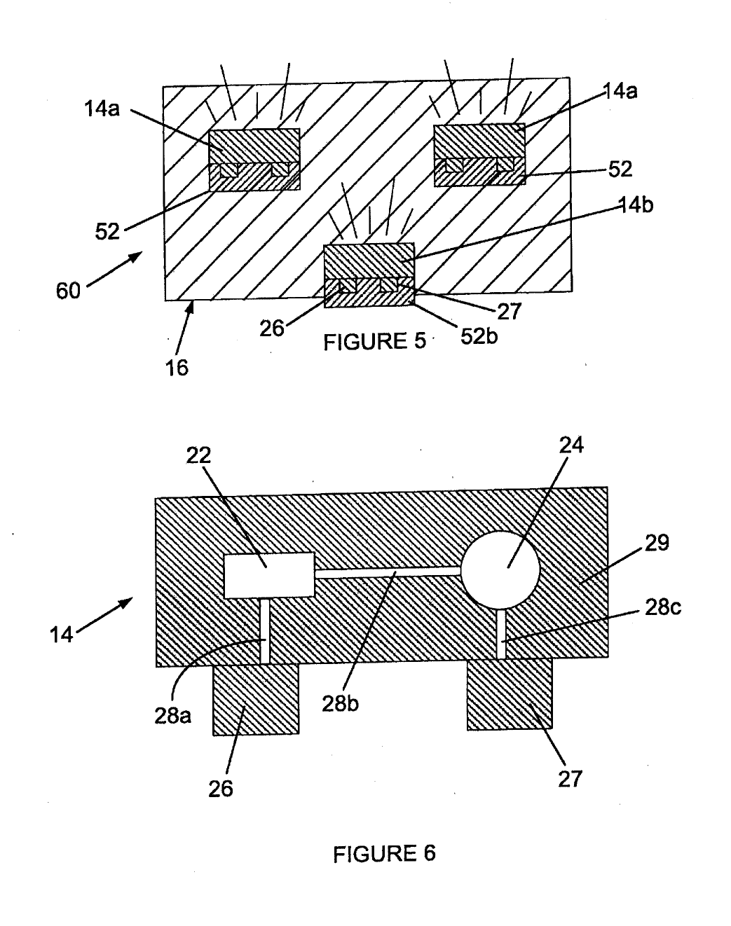

Turning now to FIG. 5, there is a cross-sectional view of another example embodiment of a soap bar 60 according to the invention. Articles 14a with the dissolvable film 52 as described above are shown dispersed in the cleaning composition 12 of the soap bar 60. Therefore, articles 14a with the dissolvable film 52 will not be described again. However, in the soap bar 60, a different article 14b is also provided. Article 14b is located at the outer surface of the soap bar 60. In order to avoid an output signal being produced by the output device 24 in the article 14b before use by a consumer, a peelable film 52b is arranged on the electrodes 26, 27 of the article 14b. This provides an electrically insulating film 52b between the electrodes 26, 27. A user can create a current path between the electrodes 26, 27 and the output device 24 in order to produce an output signal by peeling away the film 52b and placing a conductive material (e.g., water, skin) between the electrodes 26, 27. However, the film 52b prevents an output signal from the output device 24 before activation by a consumer. Various materials are suitable for use in the electrically insulating film 52b. Non-limiting example materials include silicones. The soap bar 60 can include various numbers of the articles 14a with the dissolvable film 52 and the articles 14b with the peelable film 52b.

Turning to FIG. 11, there is a detailed schematic of another example embodiment of an article 198. As detailed above, certain cleaning compositions 12 may have a conductivity sufficient to create the current path between the pair of electrodes 26, 27. In some cases, environmental conditions, such as a particular level of humidity, may combine with the certain cleaning compositions 12 to improperly create the current path between the pair of electrodes 26, 27. In order to avoid an output signal being produced from an output device 24 before use by a consumer, a resistor 184 (e.g., which may referred as a load resistor) can be in a current path 186 between the positive point of the battery 150 and the collector of the switching device 158 thereby placing a load on the switching device 158 and reducing the sensitivity of article 198. The resistor 184 can increase the amount of current required to energize the switching device 158 and trigger the controller 160.

The value of the resistor 184 can be calculated such that the required current flow to energize the switching device 158 and trigger the controller 160 is greater than the maximum current that can flow through the conductive cleaning composition 12 between the pair of electrodes 26, 27. The resistance of resistor 184 can therefore be selected to control a sensitivity of the article. In one implementation, where the voltage of battery 150 is approximately 4 to 4.5 volts, the resistance of resistor 184 is in the range of 5 kilo ohm to 10 kilo ohm. The resistance of resistor 184 can be adjusted depending upon the voltage of battery 150 as well as desired operation of article 198.

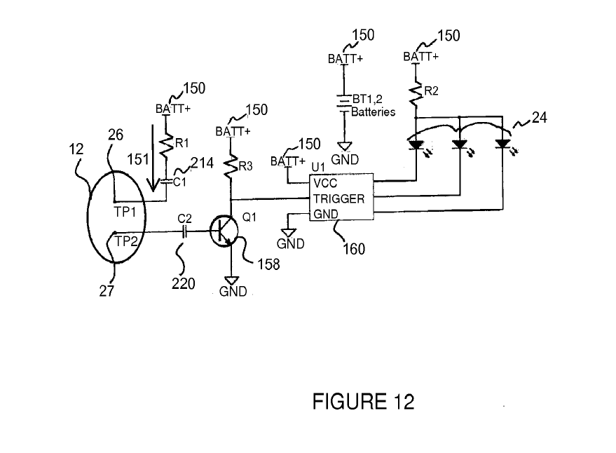

Turning to FIG. 12, there is a detailed schematic of another example embodiment of an article 200. As detailed above, certain cleaning compositions 12 may have a conductivity sufficient to create the current path between the pair of electrodes 26, 27. In order to avoid an output signal being produced from an output device 24 before use by a consumer, at least one of a first capacitor 214 and a second capacitor 220 can be in the current 151 path between the current limiting resistor 152 and the switching device 158 to prevent the switching device 158 from triggering the controller 160 when the conductivity between the pair of electrodes 26, 27 is static. Therefore, the switching device 158 will only trigger the controller 160 when there is a change in conductivity between the pair of electrodes 26, 27.

In one embodiment, the first capacitor 214 can be located in the circuit between the positive point of the battery 150 and the first electrode 26. In another embodiment, the second capacitor 220 can be located in the circuit between the second electrode 218 and the switching device 158. In still another embodiment both the first capacitor 214 and the second capacitor 220 can be located in the circuit. In some implementations, only one of capacitors 214 and 220 may be utilized. When a single capacitor is utilized, the capacitance of either of capacitors 214 or 220 may be approximately 0.01 microfarad, however in various implementations the capacitance may vary from 0.1 microfarads to 0.001 microfarads. In general, the capacitance of capacitors 214 and/or 220 can be selected depending upon the desired operation of article 200.

Turning now to FIGS. 7 and 8, there is a cross-sectional view of another example embodiment of a soap bar 70 according to the invention. The soap bar 70 has alternative means for creating a current path between the electrodes 26, 27. Specifically, a motion detection system having an open circuit position and a closed circuit position is placed in a circuit path between the electrodes 26, 27. Inversion of the soap bar 70 moves the motion detection system from the open circuit position of FIG. 7 to the closed circuit position of FIG. 8 such that the output device 24 will produce an output signal. Articles 14 are shown dispersed in the cleaning composition 12. A liquid impermeable wall 43 creates a well 44 around the electrodes 26, 27. The wall 43 can comprise, for example, a wax or a polyolefin. A conductive liquid 45 is contained in the well 44. The conductive liquid 45 does not occupy the entire volume of the well 44. When the soap bar 70 is in the open circuit position of FIG. 7, the conductive liquid 45 does not contact the electrodes 26, 27 thereby providing an electrically insulating air gap between the electrodes 26, 27. When the soap bar 70 is moved into the closed circuit position of FIG. 8, the conductive liquid 45 contacts the electrodes 26, 27 creating a current path between the electrodes 26, 27, and the output device 24 will produce an output signal. Thus, motion of the soap bar 70 can cause emission of an output signal from the soap bar 70.

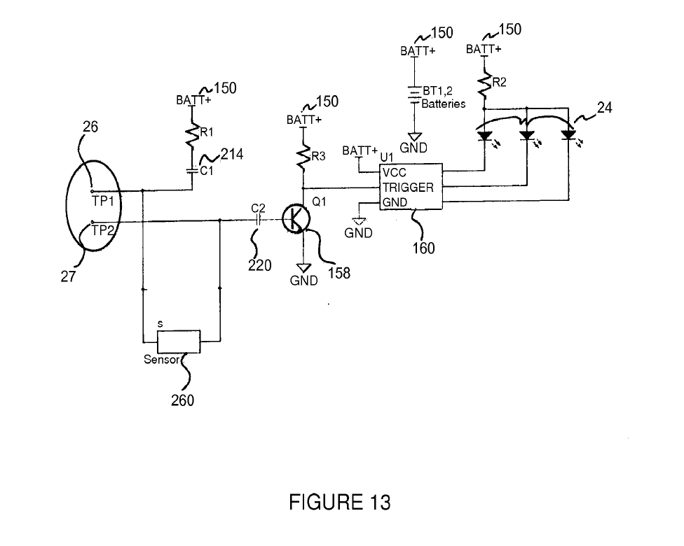

Turning now to FIG. 13, there is a schematic view of another example embodiment of an article 262. The article 262 has alternative means for creating a current path between the electrodes 26, 27. Article 262 can contain a sensor device 260 connected in parallel with the pair of electrodes 26, 27. When either of the pair of electrodes 26, 27 and sensor device 260 form a current path, switch 158 can become conductive causing the article 262 to generate an output. In some implementations of article 262 that includes sensor device 260, electrodes 26, 27 may be removed entirely so that article 262 can only be triggered by sensor device 260.

The sensor device 260 can be a plurality of sensor types including, but not limited to, a motion sensitive type sensor device, a temperature sensitive type sensor device, a pressure sensitive type sensor device, a sound sensitive type sensor device, and a light sensitive (e.g., visible light or infrared) type sensor device. Furthermore, the sensor device 260 can be a solid state or mechanical type device.

The sensor device 260 can provide a separate current path to that created between the pair of electrodes 26, 27, and can energize the switching device 158, allowing the controller 160 to trigger and thereby energizing the output device 24. The article 262 can contain a plurality of sensor devices 260 to allow for a plurality of alternative means for creating a current path between the electrodes 26, 27, where each of the sensor devices 260 may be connected in parallel. The sensor device 260 can be the primary method of creating the current path between the electrodes 26, 27. Alternatively, the sensor device 260 can be combined with any other disclosed embodiment for creating a current path between the electrodes 26, 27, such as placing a conductive material across the electrodes 26, 27 to create a current path.

For example, if the sensor device 260 includes a movement sensor connected in parallel with pair of electrodes 26, 27, switch device 158 may be energized by either movement of article 262 or a current path being formed between electrodes 26, 27. As such, when article 262 is incorporated into a bar of soap, for example, article 262 may generate an output in response to the soap getting wet or being moved. Conversely, where the sensor device 260 is connected in series with electrodes 26, 27, the article 262 would only generate a response when both conditions of being wet and being moved are satisfied.

Additionally, at least one of a first capacitor 214 and a second capacitor 220 can be in the current 151 path between the current limiting resistor 152 and the switching device 158 to prevent the sensor device 260 from triggering the controller 160 when the current path between the pair of electrodes 26, 27 is static (i.e., capacitors 214 and 220 block the flow of direct current (DC) signals to switching device 158). Therefore, the switching device 158 will only trigger the controller 160 when there is a change in conductivity between the pair of electrodes 26, 27, which can result from a change of state of the sensor device 260.

The inclusion of at least one of capacitors 214 and 220, therefore, can reduce the frequency with which article 262 can be triggered. This may be useful, for example, to prevent excessive triggering of article 262 that may occur due to movement of article 262, where article 262 includes a movement sensor configured to trigger the article. If the movement sensor includes a ball bearing switch, for example, that closes when the article 262 is in a first position and opens when article 262 is in a second position, article 262 would only be triggered when the switch initially transitions from an open position to a closed position. If the switch remains in the closed position, the article 262 would not continue to be triggered due to the operation of capacitors 214 and 220 blocking the DC current resulting from the switch being in a continuously closed state. In order to re-trigger article 262, the article 262 would first have to be moved so that the switch opens and then article 262 would have to be moved again so that the switch closes. When the switch closes article 262 would be re-triggered. This operation can prevent excessive battery draining due to movement of article 262 in circumstances where triggering of article 262 is not warranted—such as during shipping of a product incorporating article 262, or where article 262 is contained within a bar of soap that has been packed in luggage and the detected movement is due to movement resulting from the luggage being in-transit.

In various other implementations, sensor device 260 may include a sound sensor. In that case the article 262 may be triggered by a sufficiently loud sound. Sensor device 260 may also include a light sensor that is triggered by article 262 being exposed to a sufficiently strong light source: In some implementations, when the soap bar is first manufactured, soap material is configured to cover the light sensor and the soap material is selected to block sufficient light that the light sensor is not capable of being triggered. However, after user, and when sufficient soap materials has been removed that light can penetrate the soap material to the light sensor, the light sensor may be triggered. When sensor device 260 includes a movement sensor, a number of different types of sensors, such as tilt sensors, accelerometers, ball bearing tilt switches, and the like, may be utilized.

In another implementation, the sensor device 260 includes a temperature sensor, such as a thermocouple, thermistor, or a resistance temperature detector. In that case, when the temperature sensor is exposed to a sufficiently high temperature, article 262 may be triggered. This implementation, may be used, for example, to detect bathwater that exceeds a predetermined temperature. In this case, where sensor device includes a temperature sensors, depending upon the implementation of the temperature sensor, capacitors 214 and 220 are removed from the circuit. Similarly, depending upon the implementation of other types of sensor devices (e.g., DC-type sensors, such as pressure sensors), capacitors 214 and 220 may be removed from the circuit to enable operation of the sensor devices.

In another implementation, sensor device 260 is configured to detect RF signals. Depending upon the implementation, the RF sensor may detect RF signal having a particular frequency or RF signals that match a particular pattern (such as a Bluetooth signal that include a particular ID number).

In some implementations, where article 262 includes a temperature sensor, the temperature sensor may be connected to controller 160 at a separate input so that controller 160 can distinguish between input signals received due to operation of the temperature sensor and input signals received due to operation of the pair of electrodes 26, 27. This, then, enables controller 160 to generate different outputs depending upon whether the article 262 was triggered due to anticipated operation (e.g., due to use of the bar of soap), or due to a temperature being exceeded (e.g., due to the soap being placed in bath water that exceeds a predetermined temperature). In that case, the second output generated by the controller—in response a temperature threshold being exceed—may more resemble an alarm that can warn of dangerously hot bathwater.

The various sensor devices may be separate from the controller 160 (as is illustrated in FIG. 13) or may be formed integrally (e.g., within the same integrated circuit) as controller 160. Additionally, the sensor devices 260 may be connected to article 262 through switching device 158. In other implementations, though, the sensor device 260 may connect directly to controller 160, which would be configured to receive and interpret signals from the sensor devices 260.

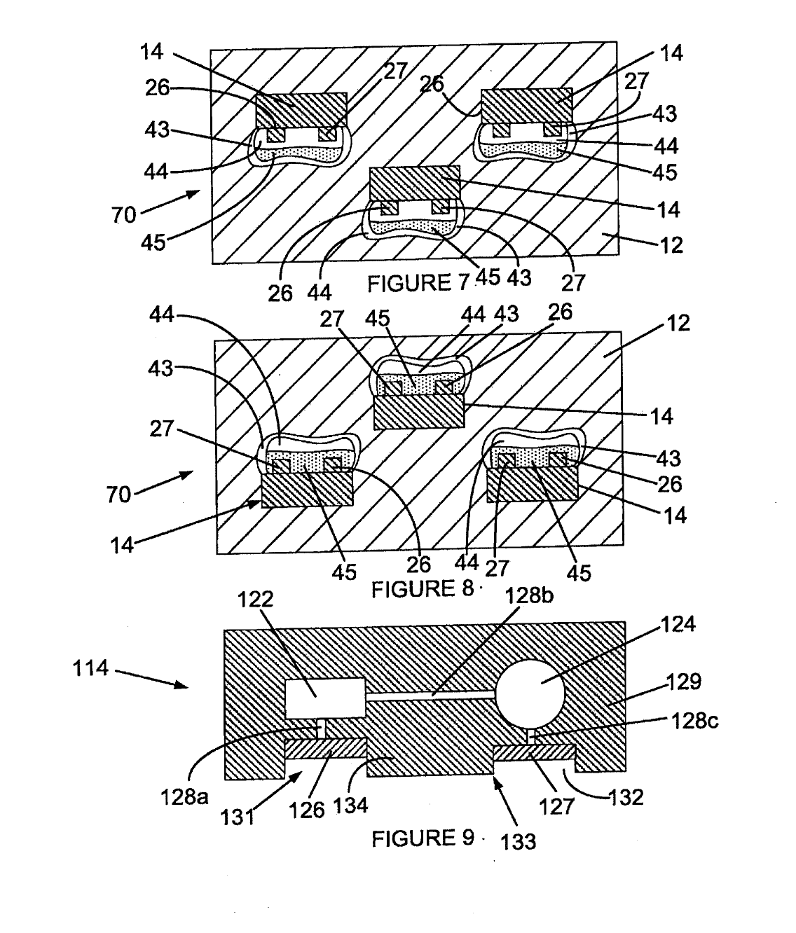

Referring now to FIG. 9, another example dispersed article 114 is shown. Article 114 can be dispersed in the cleaning composition 12. The article 114 includes an electrical power source 122, such as a battery or photovoltaic cell. The articles 114 include an output device 124 that produces an output signal as a result of an electric current from the electrical power source 122 being passed through the output device 124. A light emitting diode is one suitable output device 124. A pair of electrodes 126, 127 are arranged in spaced apart relationship. The pair of electrodes 126, 127 are in electrical communication with the electrical power source 122 and the output device 124 by way of electrical leads 128a, 128b, 128c. A housing 129 can keep the electrical power source 122, the output device 124, the electrodes 126, 127, and the electrical leads 128a, 128b, 128c assembled together. The electrodes 126, 127 are not flush with the housing 129. Note the recesses 131, 132 created in the outer surface 133 of the housing 129. The recesses 131, 132 provide control of the output device 124 in that the film of water on the housing 129 must be sufficient to create a conductive path between the electrodes 126, 127 and over the raised area 134 of the housing 129. The cleaning composition 12 in the recesses 131, 132 must first dissolve so that the water can create a current path between the electrodes 126, 127.

The soap bars 10, 40, 50, 60 and 70 can be made as follows. In a first step, a mixture with the articles 14 dispersed in the cleaning composition 12 is formed. When making a glycerin soap, one or more surfactants and glycerin (or another polyol) can be chosen for the cleaning composition 12. One preferred method for dispersing the articles 14 is by melting the cleaning composition 12 and stirring to keep the articles 14 dispersed. In a second step, the mixture is poured into molds that will give the soap bars the individual bar shape. The pouring process is preferably done at elevated temperatures to prevent the cleaning composition 12 from solidifying before it is poured into the molds. The preferred temperature is between about 120° F. to about 200° F. The articles 14 should not degrade or melt at this temperature. The location of the article 14b in the soap bar 60 can be accomplished by forming recesses in the mold wall that hold the article 14b during molding.

Thus, the invention provides a soap bar and a melt and pour soap bar formulation including a transparent or translucent cleaning composition, and a plurality of dispersed articles wherein one or more of the articles comprises a light source that produces visible light or a sound emitter.

Although the invention has been described in considerable detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

What is claimed is:

1. A soap bar comprising:
a matrix comprising a cleaning composition; and
an article positioned in the matrix, the article including:
a pair of electrodes in spaced apart relationship, the pair of electrodes being in a circuit path with an electrical source;
a switching device connected to at least one of the pair of electrodes; and
a controller connected to the switching device;
wherein the switching device provides an input signal to the controller when a conductive material creates a current path between the pair of electrodes;
wherein, when the controller receives the input signal from the switching device, the controller generates an output signal.

2. The soap bar of claim 1, including a resistor connected to the switching device.

3. The soap bar of claim 1, including a capacitor connected to at least one of the pair of electrodes.

4. The soap bar of claim 1, including an output device, and wherein the output signal causes the output device to operate.

5. The soap bar of claim 4, wherein the output device includes a light emitting device, a vibration emitting device, a sound emitting device, or a radio frequency signal transmitting device.

6. The soap bar of claim 4, wherein the output device includes a light emitting device.

7. The soap bar of claim 4, wherein the output device includes a vibration emitting device.

8. The soap bar of claim 4, wherein the output device includes a sound emitting device.

9. The soap bar of claim 4, wherein the output device includes a radio frequency signal transmitting device.

10. The soap bar of claim 1, including a sensor device connected to the switching device, the sensor device being configured to cause the switching device to provide the input signal to the controller in response to an environmental condition.

11. The soap bar of claim 10, wherein the sensor device is configured to detect changes in pressure.

12. The soap bar of any claim 10, wherein the sensor device is configured to detect sound.

13. The soap bar of claim 10, wherein the sensor device is configured to detect changes in light.

14. The soap bar of claim 10, wherein the sensor device is configured to detect changes in temperature.

15. The soap bar of claim 10, wherein the sensor device is configured to detect radio frequency signals.

16. The soap bar of claim 1, wherein the matrix is a solid or semi-solid matrix.

17. The soap bar of claim 1, wherein the matrix is transparent or translucent.

18. The soap bar of claim 1, wherein a section of the matrix covers the pair of electrodes and prevents the conductive material from creating the current path until the section of the matrix is removed thereby uncovering the pair of electrodes.

19. The soap bar of claim 18 wherein:
the conductive material comprises water,
the section of the matrix comprises a portion of the cleaning composition covering the pair of electrodes, and
the portion of the cleaning composition dissolves in the water thereby uncovering the pair of electrodes.

20. The soap bar of claim 18 wherein:
the article is positioned at an outer surface of the matrix,
the section of the matrix comprises a non-conductive peelable film covering the pair of electrodes adjacent the outer surface of the matrix, and
the film is suitable for being removed thereby uncovering the pair of electrodes.
